(19) United States
(12) Patent Application Publication
(10) Pub. No.: US 2026/0358173 A1
(43) Pub. Date: Nov. 12, 2026

(54) SPECTRAL LIGHT SENSOR AND CORRESPONDING SENSING METHOD

(71) Applicants: ams-OSRAM AG, Premstaetten (AT); ams-OSRAM International GmbH, Regensburg (DE)

(72) Inventors: Matt KROESE, Melissa, TX (US); Josef KRIEBERNEGG, Graz (AT); Helmut THEILER, Lieboch (AT); Desislava OPPEL, Sankt Bartolomae (AT); Bingbing XU, Suzhou, Jiangsu (CN)

(21) Appl. No.: 19/137,612

(22) PCT Filed: Dec. 12, 2023
(86) PCT No.: PCT/EP2023/085437

§ 371 Date: Jun. 10, 2025

Related U.S. Application Data
(60) Provisional application No. 63/432,283, filed on Dec. 13, 2022.

(51) Int. Cl. G01J 3/28; G01J 3/12; G01J 3/45

(52) U.S. Cl. CPC G01J 3/2803; G01J 3/45; G01J 2003/1226

(57) ABSTRACT

Described is a cost-efficient and simple light sensor with red, green, and blue optical channels which has a high sensing accuracy and stability at varying incident angles, in particular for illuminance and color temperature measurements. The red channel comprising at least one primary red photodiode with a first filter stack and at least one supplemental photodiode with a second filter stack, the first filter stack comprising an UV-IR blocking interference filter and a red absorption filter the second filter stack comprising an interference band-pass filter and an absorption filter, the primary red photodiode and the supplemental photodiode both feeding into a common analog ALS engine or into an evaluation unit configured to add their individual responses to form a red channel output such that the supplemental photodiode's response at least partially compensates for a loss of the primary red photodiode's response over an varying angle of incidence of incoming light.

### TECHNICAL FIELD

The invention is related to a spectral light sensor with red, green, and blue optical channels. It is also related to a corresponding sensing method.

### BACKGROUND

Existing light sensors with red, green, blue (RGB) and, if applicable, clear optical channels are susceptible to sensing inaccuracies due to angular shift, i.e., when the angle of incident light relative to the optical axis varies over time or relative to a calibration or reference alignment.

### SUMMARY

An objective underlying the present invention is to provide a cost-efficient and simple light sensor with RGB optical channels which has a high sensing accuracy and stability at varying incident angles, in particular for illuminance and color temperature measurements. A corresponding sensing method shall be given as well.

With respect to the light sensor, the objective is met by a light sensor according to claim 1. The corresponding method is specified in claim 8.

Accordingly, there is a light sensor with red, green, and blue optical channels, the red channel comprising at least one primary red photodiode with a first filter stack and at least one supplemental photodiode with a second filter stack, the first filter stack comprising an UV-IR blocking interference filter and a red absorption filter, the second filter stack comprising an interference band-pass filter and an absorption filter, the primary red photodiode and the supplemental photodiode both feeding into a common analog ALS engine or into a common evaluation unit which is configured to add their individual responses to form a red channel output, such that the supplemental photodiode response at least partially compensates for a loss of primary red photodiode response over an varying angle of incidence of incoming light.

In short, the light sensor according to the invention has at least two pixels with different filter combinations (and therefore different spectral responses) feeding into the same red channel output. The supplemental photodiode adds response to the red channel which compensates for the loss of response over angle due to the interference filter's cut-off wavelength shifting.

In other words, the filter stack (comprising an absorption and an interference filter) on the supplemental photodiode uses a unique interference filter that spectrally shifts preferably at the same rate as the UV-IR blocking filter used on the primary red channel photodiode. The filter stack on the supplemental photodiode is therefore designed to increase response over angle that matches the loss of response over angle for the filter stack on the primary red channel photodiode.

This enables accurate and stable illuminance and color temperature measurements at varying incident angles, which, among others, is an important improvement for applications of display management and camera enhancement widely used in mobile devices such as smartphones.

Beyond the solved problem of angular shift and the achieved stable color channels ratios at changing incident angles, the combined absorption and interference filters stack provides several other advantages:
low-cost components
low-cost production process
zero device height increase
low complexity
ease of system integration
no field of view limitation
no sensitivity loss

In particular, the invention allows for use of lower cost packaging since no package aperture is required. Furthermore, the invention allows for lower cost system design as no diffuser is required.

In a preferred embodiment, the absorption filter of the second filter stack is a green absorption filter. Preferably, the green absorption filter has a transmittance maximum in the range of 500 nm to 550 nm, preferably with a falling edge in the visible region.

In general, there are other absorption filters available like CMY (Cyan, Magenta, Yellow) where Cyan and Magenta could possibly be used. However, Green is the most cost effective for an RGB sensor.

Furthermore, it is preferred that the interference band-pass filter has a passband with a lower wavelength limit in the range of 525 nm to 645 nm, in particular 585 nm, with respect to vertically incident light. Preferably, the passband has an upper wavelength limit in the range of 600 nm to 720 nm, in a preferred example 685 nm, with respect to vertically incident light.

Advantageously, the Spectral Shift of the Interference Band-pass filter response over angle of incidence matches the spectral shift of the UV-IR blocking interference filter response.

Expediently, the green and blue channel each comprise a photodiode with a filter stack which compromises an UV-IR blocking interference filter and either a green or a blue absorption filter.

In a useful application, a device, in particular a mobile phone, a tablet, a portable computer, a wearable, a TV set, or the like, with a light sensor of the aforementioned kind is configured for the sensing of ambient light and/or for determining a correlated color temperature and/or for camera image processing. The invention allows for better display (color) quality, better picture (color) quality, and/or better correlated color temperature (CCT) sensing accuracy.

A corresponding method of spectral sensing of light,

preferably ambient light, is based on a light sensor with red, green, and blue optical channels, the red channel comprising at least one primary red photodiode with a first filter stack and at least one supplemental photodiode with a second filter stack, the first filter stack comprising an UV-IR blocking interference filter and a red absorption filter, the second filter stack comprising an interference band-pass filter and an absorption filter, wherein the primary red photodiode response and the supplemental photodiode are combined, in particular added, to form a red channel output, such that the supplemental photodiode response at least partially compensates for a loss of primary red photodiode response over an varying angle of incidence of incoming light.

What has been said with respect to the device may analogously be applied to the method, and therefore need not be repeated here. Method embodiments and details have a counterpart in the device and vice versa.

### BRIEF DESCRIPTION OF THE DRAWINGS

Expedient embodiments of the invention are now discussed with reference to the accompanying drawings.

FIG. 1 shows a schematic sectional view of a conventional light sensor with RGBC (Red-Green-Blue-Clear) optical channels.

FIG. 2 shows a transmittance diagram related to various filter responses (i.e., RGB and UV-IR filter transmission curves) for different components of the light sensor of FIG. 1 at a fixed angle of incidence.

FIG. 3 shows a response diagram related to various filter transmittances (i.e., normalized RGB output) of the entire light sensor of FIG. 1 at a fixed angle of incidence.

FIG. 4 illustrates the angular dependence or shift of the UV-IR filter response for the light sensor of FIG. 1.

FIG. 5 illustrates the angular dependence or shift of the Red and Blue channel response for the light sensor of FIG. 1.

FIG. 6 shows a light sensor with an upstream diffusor.

FIG. 7 shows a light sensor with an upstream optical aperture.

FIG. 8 shows a photodiode with an exemplary filter stack to be used as a supplemental photodiode in conjunction with a light sensor according to FIG. 1.

FIG. 9 schematically illustrates an improved red channel measurement arrangement for a light sensor, using a supplemental photodiode according to FIG. 8.

FIG. 10 shows various spectral responses for different angles of incidence in connection with a supplemental photodiode according to FIG. 8 and its individual filter components.

FIG. 11 shows the spectral red channel response for different angles of incidence of an improved light sensor with a primary red photodiode and a supplemental photodiode according to FIG. 8.

FIG. 12 shows the spectral blue and red channel responses for different angles of incidence for an improved light sensor with a primary red photodiode and a supplemental photodiode according to FIG. 8

FIG. 13 shows the ratio of blue channel response versus red channel response over angle of incidence (angular response under different type of light sources) for a conventional and an improved light sensor.

### DETAILED DESCRIPTION

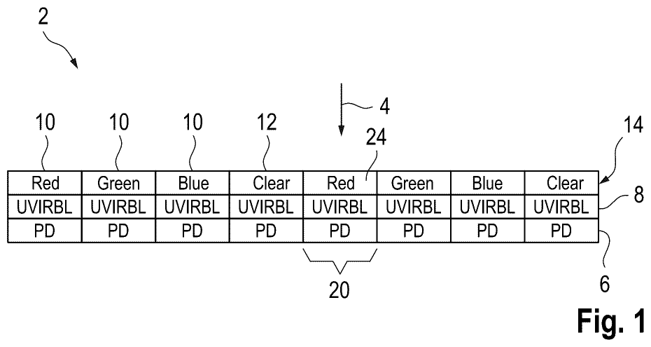

FIG. 1 shows a schematic sectional view of a light sensor 2 with RGBC (Red-Green-Blue-Clear) optical channels, also known as a RGBC sensor. The light sensor 2 comprises a plurality of optical pixels which in a view from above (along the optical path or optical axis 4) are arranged in an array or matrix configuration. Each optical pixel comprises a photodiode (PD) 6, an UV-IR blocking interference filter 8 (in particular a coating), and either a colored absorption filter 10 (in particular a coating) or a clear cover 12 (in particular a coating). More precisely, a first group of pixels is assigned a red absorption coating, a second group of pixels is assigned a green absorption coating, a third group of pixels is a assigned a blue absorption coating, and an optional fourth group of pixels is assigned a (non-colored) clear cover. Alternatively, for the clear pixels there may be no coating at all above the UV-IR blocking interference filter 8. In terms of layers, there is a photodiode layer at the bottom, an UV-IR blocking layer in the middle, and a RGBC mask 14 at the top. Generally, there is a substrate layer below the photodiode layer, but it is not shown here.

Generally, the UV-IR layer can be middle or top layer. Similarly, the RGBC layer can be middle or top layer.

The clear channel is optional. That is, in a simple RGB light sensor, there are no clear pixels. The present invention applies to both an RGB and an RGBC light sensor.

An UV-IR blocking interference filter or coating may simply be called an UV-IR filter, and the RGB absorption filters or coatings may simply be called RGB filters.

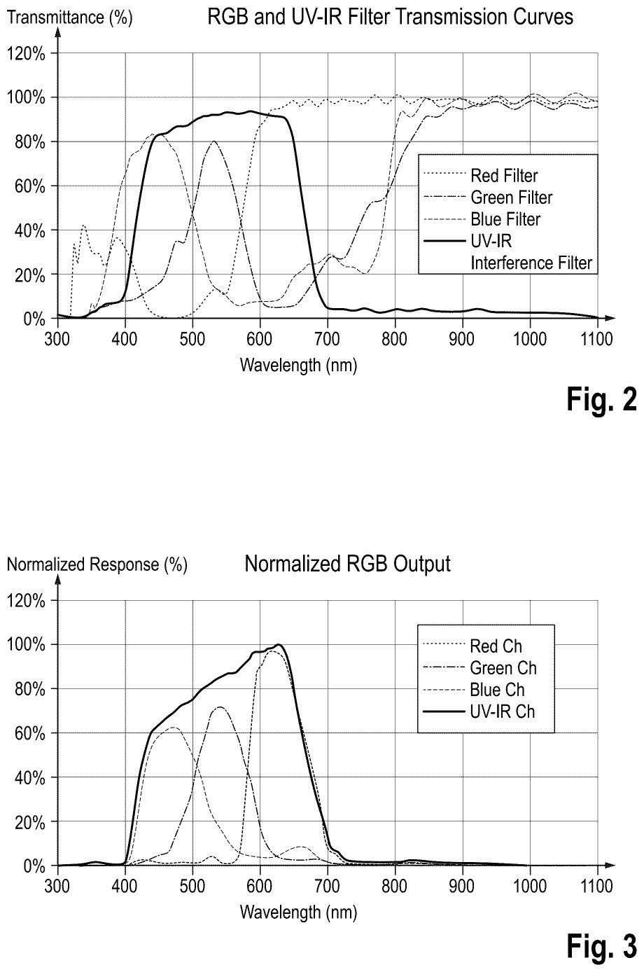

The spectral transmittance, i.e., the transmittance in % over the wavelength in nm of incident light, for the individual components of the light sensor 2 is shown in FIG. 2.

In the diagram the respective transmittance is shown for each of the RGB absorption filters 10 or coatings. The transmittance curve for the blue absorption coating has a first prominent maximum at approximately 450 nm, the corresponding first maximum for the green absorption coating is at approximately 530 nm, and the curve representing the effect of the red absorption coating has a first maximum at approximately 600 nm. Towards greater wavelengths, in the infrared (IR) region, all three curves show a rising behavior, which means that the RGB color coatings are basically transmissive for IR light. For a lesser extent this is also true for shorter wavelengths in the ultraviolet (UV) region. An optional clear coating, if present, is basically transmissive for the entire range of wavelengths.

Furthermore, the diagram in FIG. 2 shows a typical transmittance curve for the UV-IR blocking interference filter 8. In terms of transmittance this filter or coating shows a bandpass behavior, yielding high transmittance in the visible range (approximately from 400 to 700 nm), and low (almost zero) transmittance below and above the visible range. That is, light with wavelengths in the UV and IR range is blocked, while visible light is allowed to pass, hence the name UV-IR blocking filter. Usually, such filters are designed as interference filters.

The photodiode 6 of each optical channel has a spectral response behavior of its own (not shown here). The wavelength at which the photodiode 6 has maximum response is dependent on the photodiode structure. The examples shown here have a maximum at approximately 750 nm, with a relatively soft decay towards lower and higher frequencies.

For each of the optical channels of the light sensor 2 the total spectral response is obtained by combining the responses and transmittances of the individual components, i.e., the photodiode 6, the UV-IR blocking interference filter 8, and either the RGB colored absorption filter 10 or the clear cover 12. Mathematically, the respective response values are multiplied with each other for each wavelength of interest, yielding the resulting diagram in FIG. 3. The resulting spectral response for each of the RGB channels is visualized by three corresponding curves (also shown is the combined response of the UV-IR blocking filter 8 and the photodiode 6). To be precise, the normalized response in % is given as a function of the wavelength in nm. While the original positions of the transmittance maxima of the RGB curves from FIG. 1 are approximately maintained, the overall impact of the UR-IV blocking filter 8 is clearly visible, as the transmittance in the UV and IR range is nearly zero.

Summing up so far, color sensors typically use red, green, and blue (RGB) absorption filters 10. However, the RGB absorption filters 10 pass light in the IR and in the UV range which is not desired. Therefore, the RGB absorption filters 10 need to be coupled with an UV-IR blocking interference filter 8 to block the IR and UV portions of incident light.

A problem related to the conventional light sensor design of FIG. 1 emanates from the fact that the UV-IR blocking interference filter 8 has a transmittance characteristic which depends on the angle of incidence (AoI) of incoming light. Strictly speaking, the transmittance diagram for the UV-IR filter and the resulting response diagram for the RGB channels of the light sensor 2 are only valid for a fixed reference value of AoI=0°, wherein the AoI is given relative to the optical axis 4. For other AoI values the corresponding response curves are shifted relative to the reference curves.

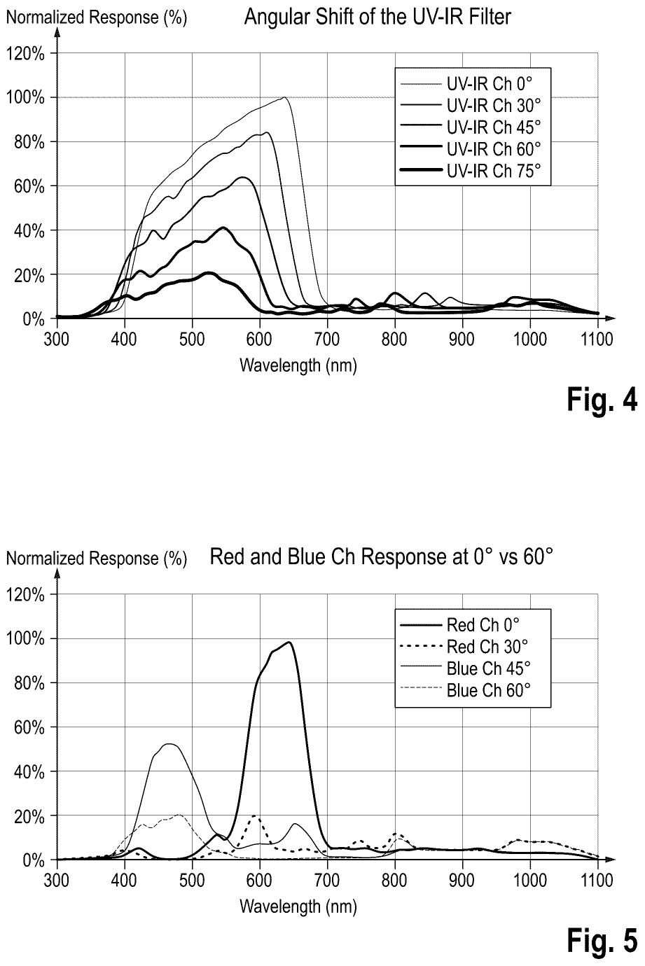

This angular shift originating from the UV-IR blocking interference filter 8 can be clearly seen in FIG. 4, wherein the spectral response of the UV-IR blocking interference filter 8 (combined with the photodiode response) is given as a normalized response in % over wavelength in nm for five different AoI values, ranging from 0°to 75°.

FIG. 5 is a similar diagram, showing the angular shift and the angle-dependent flattening of the transmittance curves for the red and the blue channels of the conventional light sensor 2 of FIG. 1. To be precise, a normalized response in % over wavelength in nm is given for the red and the blue channel for two different AoI values, namely 0°and 60°.

The red channel has a similar angular shift like the UV-IR blocking interference filter 8. The blue and green, especially the green, are less affected. This may be explained as follows: Each RGB channel is formed in combination with the UV-IR blocking interference filter 8. In other words, the UV-IR blocking interference filter 8 is common to the RGB channels and, if present, the clear channel and therefore affects them in a similar manner. In particular, the peak-height of the response curves is lowered for higher AoI values. This height reduction primarily comes from the photodiode 6 due to the reduced effective sensing area at high angles. Furthermore, there is a left shift from the UV-IR blocking interference filter 8 (towards lower wavelengths) with greater angles. However, the red channel has the most prominent or noticeable impact by the UV-IR blocking interference filter 8 since the transmittance peak in the red color range gets narrowed at high incident angles. For the green channel (not shown) said effect is less prominent, and even more so for the blue channel. Therefore, the ratio of the red channel response to the blue channel response is especially affected.

This behavior is particularly disadvantageous for sensing applications in which the output of the different channels of the light sensor 2 are compared or correlated to each other. In particular, it yields inaccurate results for illuminance (usually measured in Lux) or correlated color temperature (CCT) estimates.

In summary so far, the upper cutoff frequency of the UV-IR blocking interference filter 8 is dependent on the incident angle of light. The UV-IR blocking interference filter 8 also sets the cutoff frequency of the red channel's response which therefore is also dependent on the angle of incidence. In consequence, the red channel's response is reduced disproportionally to the blue channel's response the greater the angle is. This is disadvantageous especially for CCT performance and similar applications, wherein ideally the red channel to blue channel response ratio should remain flat (i.e., constant) over angle.

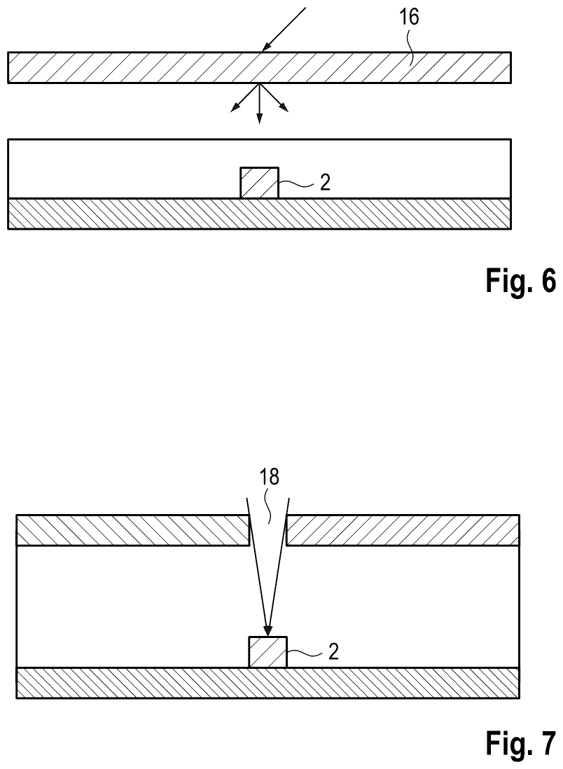

FIG. 6 illustrates a first possible remedy for said problem. The solution comprises a diffusor 16 which is placed in the path of the incoming light. The light rays emerging from the diffuser 16 are statistically distributed with respect to their direction, regardless of the angle of incidence of the incident light, yielding fixed illumination conditions for the light sensor 2 (here exemplarily shown to be arranged on a substrate).

Problems related to this approach comprise high costs for the diffusor 16, a high complexity for the integration of the diffusor 16, and a significant sensitivity reduction (a good quality diffusor 16 usually has a transmittance of less than 50%).

FIG. 7 illustrates a second possible remedy for said problem. The solution comprises an optical aperture 18 placed in the path of the incoming light, the aperture limiting the field of view (FoV) with respect to the light sensor 2 arranged further down the optical path. In other words, the optical aperture 18 blocks light with high incident angles and only allows light with nearly zero incident angles (AoI~0) to pass and reach the light sensor 2. In the example, the optical aperture 18 is a small hole or opening or otherwise optical transmissive or transparent area in a light blocking opaque or non-transparent material.

Problems related to this approach comprise an increase of device height or system height, a reduced FoV, and a significant sensitivity reduction due to the reduced FoV.

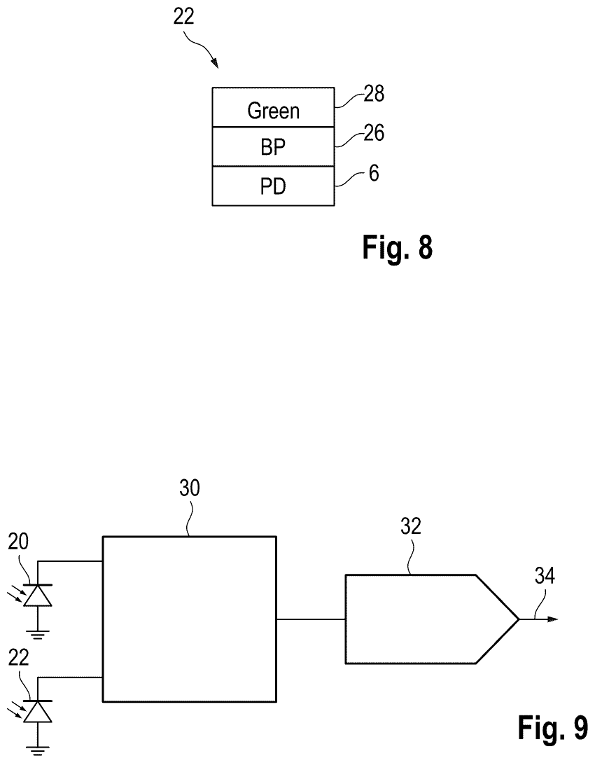

To overcome these problems, a new sensor design schematically illustrated in FIGS. 8 and 9 in conjunction with FIG. 1 is suggested. The crucial point is that apart from a conventional red photodiode (called primary red photodiode 20) a supplemental photodiode 22 adds response to the red channel to compensate and targeting to match for the varying blue channel response depending on the angle of incidence.

The primary red photodiode 20 is constructed as described above. That is, there is an UV-IR blocking interference filter 8 (in particular a coating) arranged on a photodiode 6. On top of this filter there is a red absorption filter 24 (in particular a coating). Therefore, the primary red photodiode 20 has the above-described spectral response which need not be repeated here. The various layers or coatings are preferably stacked on each other without any gaps and without any optically active intermediate layers in between, although optically non-relevant bonding layers or the like may be present.

In principle, the order of the UV-IR blocking interference filter 8 and the red absorption filter 24 may be swapped without affecting the spectral response. In practice, however, it is advantageous to apply an UV-IR blocking interference filter 8 as a coating on the photodiode 6 first, and then the red absorption filter 24 on top.

The supplemental photodiode 22, on the other hand, is constructed as schematically shown in FIG. 8. A dedicated interference band-pass (BP) filter 26 (in particular a coating) is arranged on a photodiode 6. On top of this filter there is an absorption filter 28 (in particular a coating), in particular green absorption filter.

Here too, in principle, the order of the filters in the filter stack may be swapped without affecting the spectral response. In practice, however, it is advantageous to apply an interference band-pass filter 26 as a coating on the photodiode 6 first, and then the (green) absorption filter 28 on top. Again, the various layers or coatings are preferably stacked on each other without any gaps and without any optically active intermediate layers in between, although optically non-relevant bonding layers or the like may be present.

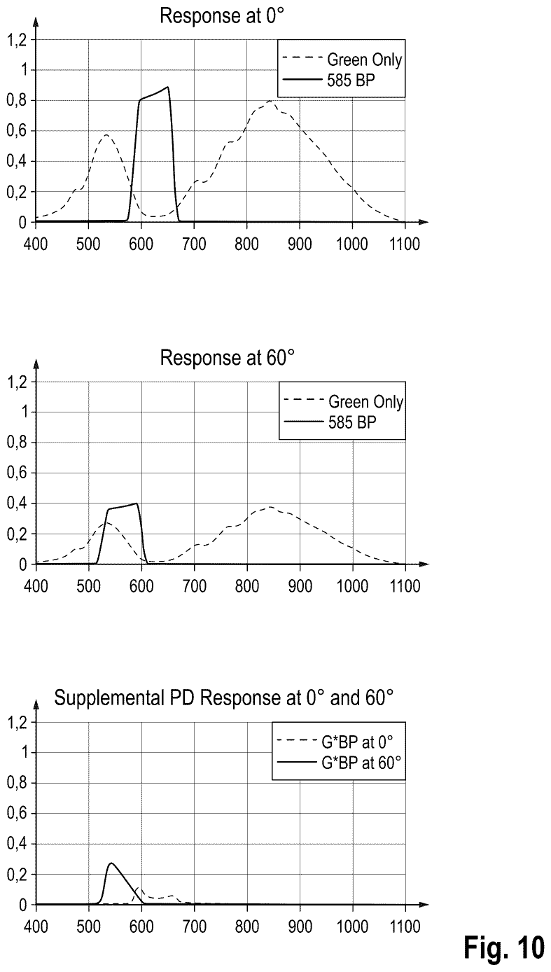

The effect of the filter stack may be understood from the three diagrams in FIG. 10.

In the uppermost diagram, for the one hand, the spectral transmittance of the green absorption filter 28 is indicated for an AoI=0°, i.e., vertical incidence of light.

Expectedly, the spectral curve which is combination of the green filter spectral transmittance and photodiode 6 spectral response (labelled Green Only) has a first maximum around 530 nm, corresponding to the green spectral region, and with a relatively steep decay or descent to both sides. In the IR region, from approximately 700 nm onwards, the green transmittance curve rises again and has a second, somewhat broader maximum centered around 850 nm.

On the other hand, the spectral transmittance of the interference band-pass filter 26 is indicated, also for an AoI=0°. As the name suggests, the band-pass is a filter that passes wavelengths within a certain range (called passband) and rejects (or attenuates) wavelengths outside that range. In this particular case the lower limit or cut-off wavelength of the passband is around 585 nm (therefore the label 585 BP), and the upper limit or cut-off wavelength is around 660 nm, with a centrum around 630 nm. In other words, the passband for an AoI=0° is located at the minimum of the green transmittance curve between the first and the second maximum and resembles, with respect to shape and location, the red absorption peak from FIG. 3 for the primary red photodiode.

In the middle diagram the green transmittance curve and the interference filter passband are shown for an AoI=60°. Generally, the green transmittance curve is somewhat flatter (with less prominent peaks) than the 0° counterpart, which is mainly caused by the smaller effective incidence area on the photodiode due to the slate angle of incidence. The same height reduction happens to the passband of the interference band-pass filter 26. More importantly, the passband of the interference band-pass filter 26 has shifted to the left, towards lower wavelengths and now overlaps with and almost covers the green absorption peak of the green absorption filter 28.

The combined effect of the filter stack on the supplemental red photodiode 22 is obtained by multiplying the individual contributions, i.e., from the interference band-pass filter 26 and the green absorption filter 28 (and the photodiode 6 as well). The resulting supplemental red photodiode's 22 spectral response, including the effect of the filter stack, is shown in the lowermost diagram of FIG. 10 for two different angles of incidence, namely AoI=0° and AoI=60°. One can see that for 0° the response of the supplemental red photodiode 22 is almost zero and therefore negligible. For larger angles like 60°, however, the response curve is shifted to the left, towards smaller wavelengths, and has a non-negligible contribution with a peak in the green range around 550 nm.

As indicated above in connection with FIG. 9, both the primary red photodiode 20 and the supplemental photodiode 22 feed their respective output into a common analog ALS engine 30 (ALS=ambient light sensor) which creates a combined output from said two signal inputs. For example, the analog ALS engine 30 may create a sum value or an arithmetic mean value or an otherwise weighted sum or combination value with additive contributions from the individual signals. The analog sum signal may be fed into an analog-to-digital converter (ADC) 32 to provide a digital red channel output 34.

In a somewhat generalized variant, the primary red photodiode 20 and the supplemental photodiode 22 don't have to connect to a common analog ALS engine 30. Rather, the supplemental diode 22 can be an independent channel with dedicated analog ALS engine and ADC of its own. With this, software implemented in an evaluation unit or control unit can access the device for the results from the primary photodiode 20 and the supplemental photodiode 22 and do mathematical compensation in software. For example, it can be a simple linear addition by applying different gain on the supplemental channel or a weighted compensation, e.g., based on the IR ratio detected in the ambient light, or any customized compensation (for example a curved compensation, a lookup table etc.) based on the specific characterization in an actual product. Additionally or alternatively, the supplemental photodiode 22 may feed into a deep learning network as an independent input.

In summary, the filter stack on the supplemental photodiode 22 comprises a (preferably green) absorption filter 28 in combination with a dedicated interference band-pass filter 26 that spectrally shifts over angle at the same or at least a similar rate as the UV-IR blocking interference filter 8 used on the primary red photodiode 20. The filter stack on the supplemental photodiode 22 is therefore designed to increase response with increasing angle of incidence, such that the increased response matches the simultaneous loss of response over angle for the filter stack (red absorption filter 24 and UV-IR blocking interference filter 8) on the primary red photodiode 20. In consequence, the supplemental red photodiode 22 adds a response to the red channel that ideally proportionally matches the relative increase of the blue channel response over angle.

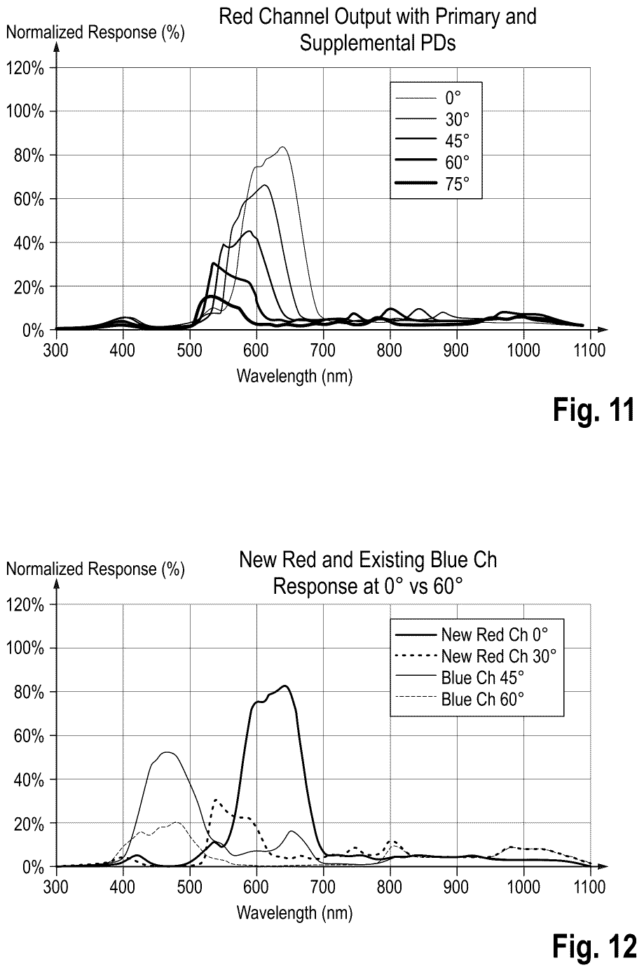

This is illustrated in FIGS. 11 and 12. The resulting red channel spectral response from the combined primary and the supplemental red photodiodes 20, 22 is shown in FIG. 11 for five different AoI values ranging from 0°to 75°. The thus modified or enhanced red channel response is shown together with a conventional blue channel response in FIG. 12 for two different angles, namely 0° and 60°. While for 0° the shape of both curves is almost identical to those curves of the conventional light sensor in FIG. 5, the loss of peak-height of the red channel response relative to the blue channel response for greater angles such as 60° is less drastic than in FIG. 5. In the example, the red channel peak remains dominant over the blue channel peak even for higher angles.

In other words, the (new) improved red channel response with the supplemental red photodiode 22 shows less change over angle than the conventional red channel without it.

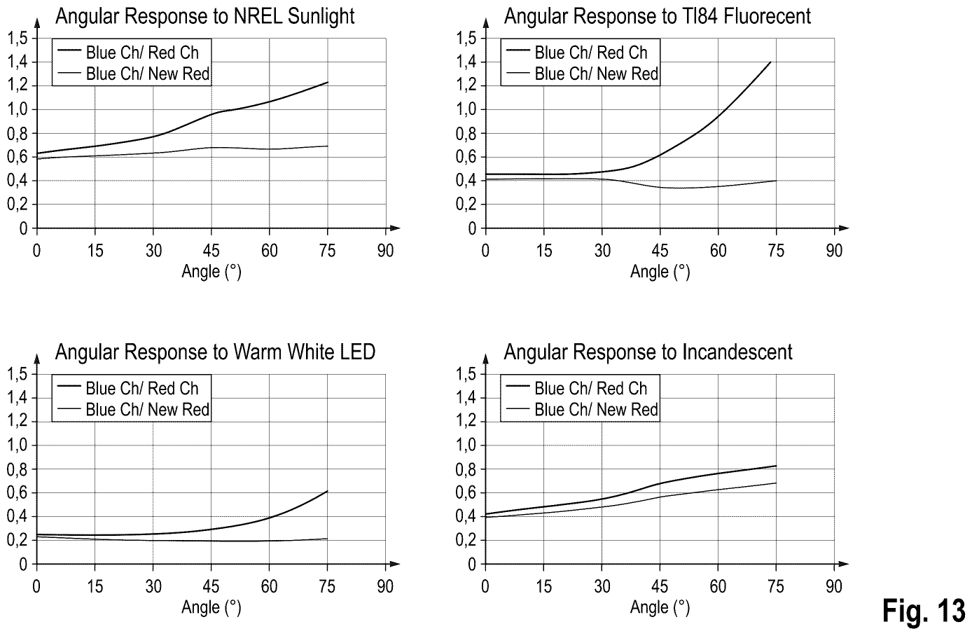

This result is further illustrated in FIG. 13, wherein each of the four diagrams shows the ratio of blue channel response versus red channel response over varying angles (from 0° to 75°), firstly for the conventional red channel and secondly for the new red channel. The upper left diagram shows said angular response for sunlight, the upper right diagram is obtained from fluorescent illumination, the lower left diagram is related to a warm white LED, and the lower right diagram is related to an incandescent. In all four cases the angular response ratio of the improved sensor is essentially flat or constant, in contrast to the original sensor design. This provides various advantages for sensing applications where accuracy and angular stability are required, in particular for illuminance and color temperature measurements.

While the invention provides the advantage that in general no upstream diffusor 16 or optical aperture 18 is necessary, each of them (alone or in combination) can still be present to achieve optimum color stability.

### LIST OF REFERENCE SIGNS

light sensor 2
optical axis 4
photodiode 6
UV-IR blocking interference filter 8
colored absorption filter 10
clear cover 12
RGBC mask 14
diffusor 16
optical aperture 18
primary red photodiode 20
supplemental photodiode 22
red absorption filter 24
interference band-pass filter 26
absorption filter 28
analog ALS engine 30
analog-to-digital converter 32
red channel output 34

1. A light sensor with red, green, and blue optical channels, the red channel comprising at least one primary red photodiode with a first filter stack and at least one supplemental photodiode with a second filter stack, the first filter stack comprising an UV-IR blocking interference filter and a red absorption filter, the second filter stack comprising an interference band-pass filter and an absorption filter, the primary red photodiode and the supplemental photodiode both feeding into a common analog ALS engine or into an evaluation unit which is configured to add their individual responses to form a red channel output such that the supplemental photodiode's response at least partially compensates for a loss of the primary red photodiode's response over an varying angle of incidence of incoming light.

2. The light sensor according to claim 1, wherein the absorption filter of the second filter stack has a falling edge in a visible region.

3. The light sensor according to claim 1, wherein the absorption filter of the second filter stack is a green absorption filter.

4. The light sensor according to claim 1, wherein the interference band-pass filter has a passband with a lower wavelength limit in a range of 552 nm to 645 nm with respect to vertically incident light.

5. The light sensor according to claim 4, wherein the passband has an upper wavelength limit in the range of 600 nm to 720 nm with respect to vertically incident light.

6. The light sensor according to claim 1, wherein a spectral shift of the interference band-pass filter's response over angle of incidence matches the spectral shift of the UV-IR blocking interference filter's response.

7. The light sensor according to claim 1, wherein the green and blue channel each comprise a photodiode with a filter stack which compromises an UV-IR blocking interference filter and either a green or a blue colored absorption filter

8. A method of spectral sensing of light by means of a light sensor with red, green, and blue optical channels, the red channel comprising at least one primary red photodiode with a first filter stack and at least one supplemental photodiode with a second filter stack, the first filter stack comprising an UV-IR blocking interference filter and a red absorption filter, the second filter stack comprising an interference band-pass filter and an absorption filter, wherein the primary red photodiode's response and the supplemental photodiode's response are combined, in particular added, to form a red channel output, such that the supplemental photodiode's response at least partially compensates for a loss of the primary red photodiode's response over an varying angle of incidence of incoming light.

9. The method according to claim 8, wherein the primary red photodiode's response and the supplemental photodiode's response are combined in a common analog ALS engine before digitization.

10. The method according to claim 8, wherein the primary red photodiode's response and the supplemental photodiode's response are combined by a software routine of an associated evaluation unit after digitization.
